(19) United States
(12) Patent Application Publication
(10) Pub. No.: US 2015/0046193 A1
(43) Pub. Date: Feb. 12, 2015

(54) CONTRACTOR SELECTION SYSTEM AND METHOD

(71) Applicant: Independent Mitigation and Cleaning/Conservation Network, Inc., Naperville, IL (US)

(72) Inventors: Patrick H HARMON, Naperville, IL (US); Nathan HART, Naperville, IL (US)

(73) Assignee: Independent Mitigation and Cleaning/Conservation Network, Inc., Naperville, IL (US)

(21) Appl. No.: 13/960,289

(22) Filed: Aug. 6, 2013

(51) Int. Cl. G06Q 40/08

(52) U.S. Cl. CPC G06Q 40/08
USPC 705/4

(57) ABSTRACT

A contractor selection server is described that assigns to each of a plurality of traits a weight percentage. A total of weight percentages is one hundred percent. For each of the plurality of traits, the contractor selection server assigns each of a plurality of contractors a rank. The contractor selection server further assigns each of the plurality of contractors a weighted rank. Each weighted rank is calculated by summing products of a contractor's rank and a trait's weight percentage for each of the plurality of traits. The contractor selection server also selects a contractor from among the plurality of contractors based on a weighted rank of the contractor.

### TECHNICAL FIELD

The technical field relates generally to a data processing system for selecting a contractor for a job. More specifically, the data processing system provides for assigning weight percentages to several traits, and then selecting a most appropriate contractor given performance metrics of the contractor with respect to the traits and given a particular weight percentage assigned to each trait.

### BACKGROUND

Comprehensive insurance claims management systems are known in which insurance adjusters, contractors, and insureds interact to resolve insurance claims. Some of the objectives of these insurance claims management systems are improved document/photograph handling, improved record keeping, and generally improved organization of data. Unfortunately, conventional claims management systems have underlooked an important area of the insurance claims resolution process: the distribution and/or assignment and/or dispatching of contractors to a job at the site of loss.

Conventionally, assignment of jobs to contractors, either by an insurance company or by an intermediary, involves assignment based on a simple round-robin approach. Unfortunately, the round robin approach fails entirely to consider any number of factors and/or traits that might affect a particular contractor's appropriateness for a job. The embodiments disclosed herein use weight percentages applied to various contractor traits to more appropriately and/or equitably assign jobs to contractors.

### SUMMARY

Accordingly, a first embodiment disclosed herein is directed to a contractor selection server comprising a transceiver, an electronic data storage, and a processor. The transceiver is operable to transmit and receive communications over at least a portion of a network. The processor is cooperatively operable with the transceiver and the electronic data storage.

The processor is configured to assign to each of a plurality of traits a weight percentage. A total of weight percentages is one hundred percent. The processor is further configured, for each of the plurality of traits, to assign each of a plurality of contractors a rank.

The processor is further configured to assign each of the plurality of contractors a weighted rank. Each weighted rank is calculated by summing products of a contractor's rank and a trait's weight percentage for each of the plurality of traits. The processor is further configured to select a contractor from among the plurality of contractors based on a weighted rank of the contractor.

A second embodiment disclosed herein is directed to a method of selecting a contractor. The method is implemented in a contractor selection server including a transceiver, an electronic data storage, and a processor cooperatively operable with the transceiver and the electronic data storage. The transceiver is operable to transmit and receive communications over at least a portion of a network.

The method comprises assigning to each of a plurality of traits, by the processor, a weight percentage. A total of weight percentages is one hundred percent. The method further comprises, for each of the plurality of traits, assigning, by the processor, each of a plurality of contractors a rank.

The method further comprises assigning, by the processor, each of the plurality of contractors a weighted rank. Each weighted rank is calculated by summing products of a contractor's rank and a trait's weight percentage for each of the plurality of traits. The method lastly comprises selecting, by the processor, a contractor from among the plurality of contractors based on the weighted rank of the contractor.

A third embodiment disclosed herein provides a non-transitory computer-readable storage medium, with instructions stored thereon. The instructions are to be executed by a contractor selection sever comprising a transceiver, an electronic data storage, and a processor, the processor being cooperatively operable with the transceiver and the electronic data storage. When executed by the contractor selection server, the instructions cause the contractor selection server to perform the method of selecting a contractor described above.

The purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a chart illustrating contractor traits and corresponding weight percentages.

FIG. 2 is a chart illustrating contractor ranks and weighted ranks

FIG. 3 is a block diagram illustrating a contractor selection network.

FIG. 4 is a block diagram illustrating a contractor selection server.

FIG. 5 is a flow chart illustrating a contractor selection method.

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to use weighting applied to various contractor traits to more appropriately and/or equitably assign jobs to contractors. More specifically, a contractor selection server operates to match a contractor to a potential loss and/or mitigation event, i.e. a job. The contractor selection server creates a list of available contractors servicing a particular type of job. The list of contractors is then analyzed and ranked according to key statistics and performance metrics over the last thirty days or over some other predetermined time frame.

The contractor selection server attempts to balance the work load among all available contractors equitably. The contractor selection server uses several objective contractor traits in achieving an equitable distribution of work. However, the contractor selection server does reward contractors that score higher in customer satisfaction statistics and in compliance measurements relating to policies of an administrate enterprise that operates the contractor selection server.

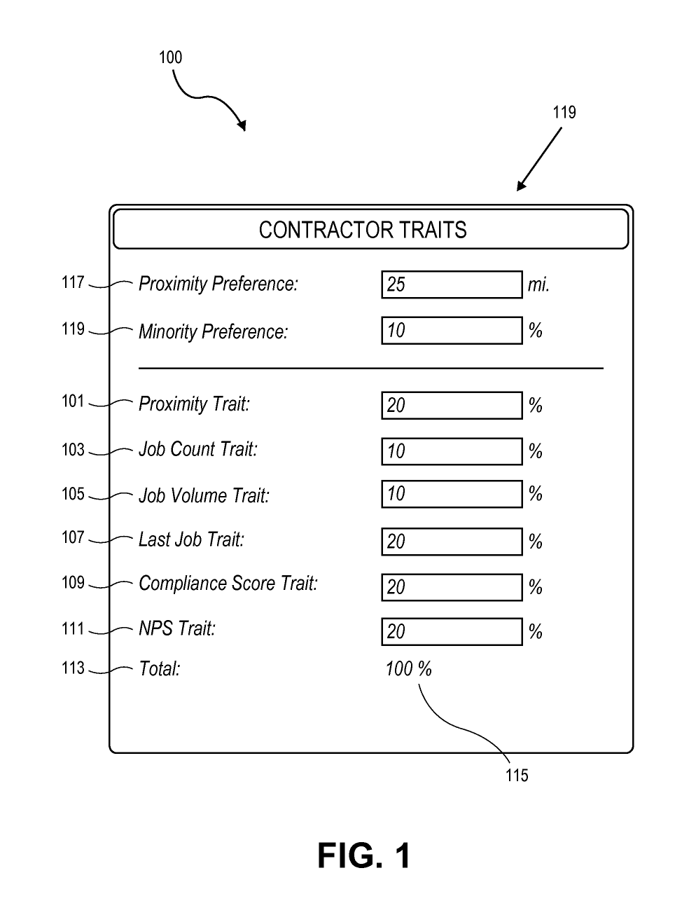

A detailed explanation of the operation of the contractor selection server, including descriptions of the various contractor traits, the weighting process, and the ranking process are now provided. Initially then, FIG. 1 is a chart 100 showing exemplary contractor traits 119 and corresponding weight percentages is discussed. Specifically, the chart 100 shows two global contractor traits 117, 119 and six scoring traits 101, 103, 105, 107, 109, 111.

The two global traits 117, 119 that are seen in chart 100 are used by the contractor selection server before any ranking or scoring of contractors is performed. The first illustrated global trait is the proximity preference global trait 117. The second global trait is the minority preference global trait 119.

The proximity preference global trait 117 is the trait used to populate a list of potential contractors for a particular job. Specifically, the proximity preference global trait 117 sets a boundary for the list of contractors created by the contractor selection server by referencing contractor information stored in the contractor selection server. The boundary is the radius (in standard measurement of distance, for example, miles, kilometers, etc.) from the particular job.

Thus in the example illustrated by FIG. 1, the proximity preference global trait 117 establishes that all contractors within twenty five miles of a referred job will be included in a list of potential contractors to be assigned the job. If the contractor information stored in the contractor selection server fails to provide a predetermined requisite number of potential contractors based on a first radius of the first proximity preference global trait 117, ten miles may be added to extend the radius, and the contractor information stored in the contractor selection server may again be referenced to determine potential contractors.

This process may be repeated until either the radius reaches a maximum distance (for example, 75 miles) or until a single qualified contractor is determined. If the radius reaches a maximum distance without a single qualified contractor being determined, the enterprise administrator of the contract selection server may be automatically alerted so that the administrator can use non-data processing techniques for determining a contractor to fill the referred job. As well, the enterprise may be alerted that future membership planning is required.

The second global contractor trait is the minority preference global trait 119. This global trait represents a set aside of jobs by volume that will be assigned to minority-owned contractors ahead of non-minority-owned contractors, up to the set aside percentage. As illustrated in FIG. 1, an exemplary set aside for the minority preference global trait 119 is 10%. Calculations of volume are performed over a rolling predetermined period of time.

Thus, for example, if over the past thirty days prior, a total volume of jobs is $1,000,000, and the minority preference global trait 119 is set to 10%, if less than $100,000 in job volume has been performed by minority-owned contractors, any available minority-owned contractor will be assigned the current referred job. If the contractor selection server determines that no minority-owned contractors is available given other global contractor traits (i.e., within 75 miles of the job site), or that the volume of work already assigned to minority-owned contractors in the previous thirty days exceeds the minority preference percentage, then no preference is given to minority-owned contractors.

In some sense, certain global contractor traits such as the proximity preference global trait 117 can be viewed as a predetermined condition. A list of contractors, that is a plurality of contractors, will include only contractors that meet the predetermined condition. Maximum distance from a job site may be one such predetermined condition, but there certainly are others known to those of skill in the art.

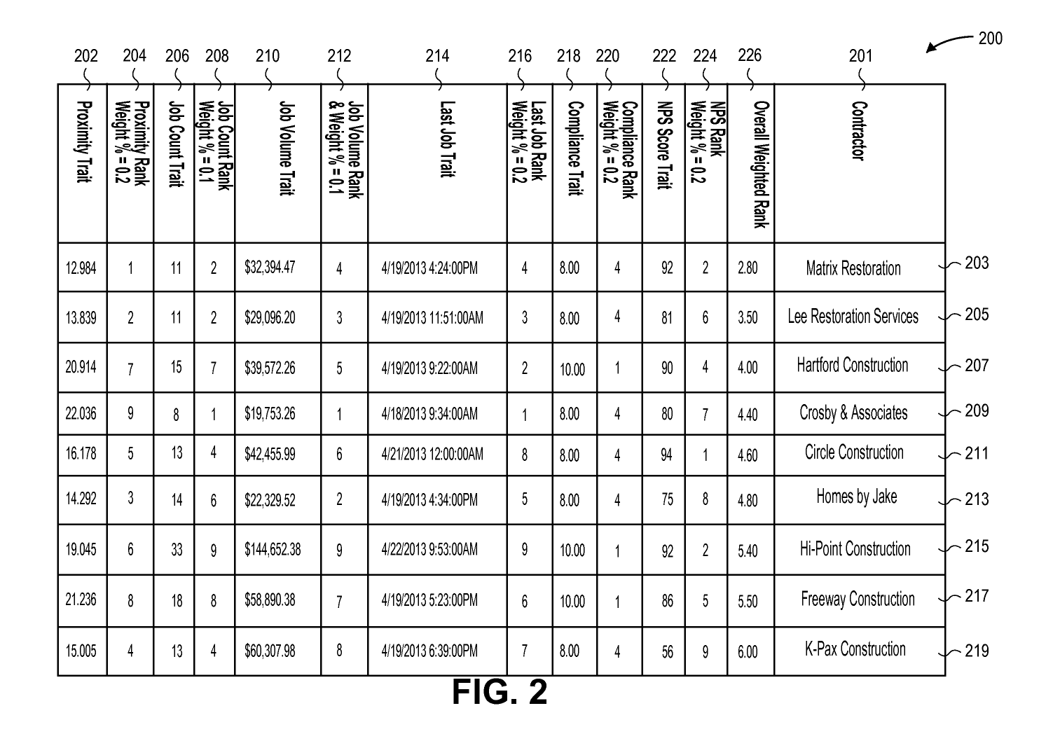

It should be noted that the minority preference global trait 119 is not a predetermined condition applied prior to population of a list of available contractors. Rather, the minority preference global trait 119 is applied after an overall weighted rank is calculated for each contractor. This is described further below after the discussion of FIG. 2.

Turning now to the scoring contractor traits, these traits may also be referred to as general contractor traits, contractor traits, or simply traits. As mentioned above, FIG. 1 illustrates six exemplary scoring traits 101, 103, 105, 107, 109, 111. These six traits would aid in determining a weighted rank or score for each contractor that would be calculated for every referred job to the enterprise operating the contractor selection server.

The contractor selection server operates so as to rank contractors generally from among a list of possible contractors. In order to rank the contractors generally, the contractor selection server must rank contractors with respect to each of the scoring traits. Thus, the contractor selection server operates to record or store, for each contractor, a score or measurement with respect to each scoring trait.

One manner of determining a most suitable contractor would simply be to directly rank contractors. This would require, for each contractor, comparing the measurements or scores for each scoring trait, determine a ranking for each trait, and then simply averaging all the ranks Thus, if a contractor had ranks of 1 of 9, 4 of 9, 8 of 9, 2 of 9, 6 of 9, and 2 of 9 for six scoring traits, the contractor's average rank would be 3.83. The ranks of all the contractors would be calculated, and the best ranking contractor would be assigned a job. However, the contractor selection server further provides taking into account preferences of the scoring traits. That is to say, the claimed and disclosed embodiments herein describe assigning weighs to each of the scoring traits so that a user or administrator can emphasize certain traits over the other. The distribution of percentages to weights assigned to the scoring traits must equal 100%. That is to say, a total of weight percentages assigned to scoring traits is 100%.

A detailed example of the weighted scoring process is discussed further below with respect to FIG. 2. It should be simply noted for now that a weight percentage is assigned to each scoring trait. A weighting schedule may be provided an insurer who wants input on selection of contractors or it can be provided by the enterprise administrator of the contract selection server. A weighting schedule may be set by default which is the likely scenario where an insurance company is not seeking to provide input. It should be noted that a weighting schedule can even be varied depending on the particular type of job that will be performed by the selected contractor. Thus it should be clear that a weighting schedule may be in effect for each different insurance company or other user, and that there may even be several different weighting schedules for each insurance company, including a different schedule for each type of job.

Each of the plurality of scoring traits is now discussed. Initially, the proximity trait 101 is a trait that is similar to the proximity preference global trait 117 in that it focuses on distance from a job site. However rather than being a boundary distance, the proximity trait 101 is a measurement of a distance of a contractor's reported physical location to the referred loss. When ranking contractors according to the proximity trait 101, the lower the number the better the rank. That is to say, it is preferable to be closer to the source of loss than farther.

As discussed above, an issue facing an insurer or other user is how important is distance to the loss site. As can be seen in FIG. 1, the proximity trait 101 is assigned a weight of 20% or simply 0.2. Thus the proximity trait 101 is slightly more important than average (1/6=0.17) but not much more important than average.

The second scoring trait is the job count trait 103. The job count trait 103 is simply the number of jobs referred to the contractor in a previous period of time, for example, thirty days. The job count trait 103 is typically an integer number.

When ranking contractors according to the job count trait 103, the lower the number of jobs means a better the rank. That is to say, it is preferable to have been assigned fewer jobs in the prior period. The reason it is preferable is because it is more equitable to assign work to a contractor who has previously received less work as reflected in the number of jobs assigned.

Of course, an issue facing an insurer or other user is how important is the number of jobs previously assigned to a contractor. As can be seen in FIG. 1, the job count trait 103 is assigned a weight of 10% or simply 0.1. Thus the job count trait 103 is less important than average.

The third scoring trait is the job volume trait 105. Job volume is determined by the estimate values for jobs referred to a job contractor in a previous period of time, for example, thirty days. The job volume trait as a measurement of total estimates values is typically measured in currency.

When ranking contractors according to the job volume trait 105, the lower the currency total means a better rank. That is to say, it is preferable to have a total volume of jobs in the prior period that is a low number. The reason it is preferable is because it is more equitable to assign work to a contractor who has previously received less work as reflected in the volume of business.

Of course, an issue facing an insurer or other user is how important is the volume of jobs previously assigned to a contractor. As can be seen in FIG. 1, the job volume trait 105 is assigned a weight of 10% or simply 0.1. Thus the job volume trait 105 is therefore less important than average.

The fourth scoring trait is the last job trait 107. The last job trait 107 describes the date of the most recent job assigned to a contractor. It should be clear that the unit of measure of the last job trait 107 is a date and time.

When ranking contractors according to the last job trait 107, the more remote from the current date the better. That is to say, it is preferable for a contractor to have been assigned a job as far back as possible. The reason it is preferable is because it is more equitable to assign work to a contractor who has not received work very recently.

Of course, an issue facing an insurer or other user is how important is the day and time of the last job of a contractor. As FIG. 1 shows, the last job trait 107 is assigned a weight of 20% or simply 0.2. Thus the last job trait 107 is therefore more important than average.

The fifth scoring trait is the compliance score trait 109. The compliance score trait 109 is a measure how well a contractor follows compliance protocols of the enterprise that operates the contractor selection server. That is to say, the compliance score trait 109 measures how compliant a contractor has been in the past with rules and procedures of the enterprise that operates the contractor selection server.

The compliance score trait 109 may be scored by points that are awarded and deducted based on the level of compliance. For example, every contractor that participates with the enterprise operating the contractor selection server to receive work would be assigned a base level number of eight (8) points. When a certain number of positive acts (as provided in, for example, a binding written agreement) are undertaken by a contractor, the contractor would be awarded two (2) points, increasing the contractor's total to ten (10) points. Similarly, when a certain number of negative acts (also as provided in a binding written agreement) are undertaken by a contractor, the contractor would be deducted two (2) points, decreasing the contractor's total to six (6) points.

The compliance trait 109 may be tracked manually by employees of the enterprise that operates the enterprise contract selection server. That is to say, these employees may monitor activity on an insurance claims management system that the enterprise operates concurrently with the contractor selection server. Alternatively, compliance by a contractor may be monitored in automated manner.

Some factors that affect a score related to the compliance trait 109 are now provided. A first factor that may be considered is claim cycle time, which is generally the time between the start of a job and the completion of a job. With a water or fire damage mitigation job, claim cycle time would specifically measure the time to complete a job from date of assignment to date of completion of mitigation. For a reconstruction job, the claim cycle time would be measured from date of inspection to date of completion of reconstruction.

Judging whether a claim cycle time is too slow (possibly resulting in a deduction of compliance trait 109 points) may occur according to specific schedule. For example, in reconstruction claims, and for losses that are $7,000 or less, usually $1000 of work can be completed per day. For losses between $7,000 and $15,000, usually $1,500 of work can be completed per day. For losses between $15,000 and $25,000, usually $2,000 of work can be completed per day. Finally, for losses of $25,000 or more, usually $2,500 of work can be completed per day. It is thus possible to calculate approximately how long it should take a particular contractor to complete a reconstruction job. Accordingly, it also possible to determine whether claim cycle time should be adjusted based on contractor compliance. Similar schedules may be provided for loss relating to replacing home contents, fire or water damage mitigation, textile restoration, electronics replacement and/or repair, and many others that are known in the art.

A second factor that may be considered in determining whether compliance trait points should be awarded or deducted is the number or percentage of canceled claim referrals. A canceled claim referral simply indicates that for any reason an insured chooses not to employ a contractor referred by the enterprise that operates the contractor selection server. An average cancelation rate can be determined for an enterprise that operates a contractor selection server.

For example, an overall cancelation rate may be approximately 25%-26%. Thus if a particular contractor exhibits a cancelation rate that is lower than 21%, the particular contractor would be viewed as providing above average service and possibly be in line to receive compliance trait points. Any contractor with a cancelation rate between 21% and 31% would be considered as providing average service would likely neither have compliance trait points awarded not deducted. Lastly, any contractor with a cancelation rate higher than 31% would be viewed as providing below average service and possibly be in line to have compliance trait points deducted.

A third factor that may be considered in determining whether compliance trait points should be awarded or deducted is the amount of time it takes for a contractor to upload a written estimate to an insurance claims management system that operates concurrently with the contractor selection server. An average time to upload an estimate after an inspection is approximately 48 hours. Uploading an estimate in any time reasonably shorter than 48 hours below would be considered very good service, and would possibly result in a contractor being awarded compliance trait points. Uploading an estimate in any time reasonably longer than 48 hours below would be considered somewhat poor service, and would possibly result in a contractor being deducted compliance trait points.

The three factors described above are just a few of several factors that may be used to determine whether compliance trait points should be awarded or deducted. The three factors above have been described in some detail in order to demonstrate the nature of awarding and deducting points based on the compliance trait. The following is a list of other factors that may be the basis of a compliance trait point awards or deductions: the number of photos of source of loss; initial photo upload time; affected area photo descriptions; number of completed work photos; the number of CMS requests for documentation; number of missed calls from a dispatch center of the enterprise that operates the contractor selection server; and contractor Net Promoter Score™ (NPS™), discussed further below.

As indicated above, when ranking contractors according to the compliance score trait 109, the higher the number of points the better. It is of course preferable to have a high number of compliance trait points indicating that the contractor is doing an above average job in complying with protocols of the enterprise that operates the contractor selection server.

Of course, an issue facing an insurer or other user is just how important is the compliance score trait. As FIG. 1 shows, the compliance score trait 109 is assigned a weight of 20% or simply 0.2. Thus the compliance score trait 109 is slightly more important than average.

The sixth score trait is the Net Promoter Score™ (NPS™) trait 111. As is well known in the art, the NPS™ results from a customer satisfaction survey that is provided to every insured after the completion of work at the source of loss. Although, the processes of the NPS™ are beyond the scope of this disclosure, it should be quickly noted that one of the primary questions of the survey is whether the customer would recommend the contractor or would not recommend the contractor, or whether the customer has no opinion with respect to a recommendation or lack thereof.

If the customer would recommend the contractor, the contractor receives a score of one hundred (100). If the customer would not recommend the contractor, the contractor receives a score of negative one hundred (−100). If the customer has no opinion (that is, neither “recommend” nor “not recommend” the contractor, the contractor is assigned a score of zero (0). After several surveys have been promulgated, a mean score of the NPS™ will develop for each contactor.

When ranking contractors according to the NPS™ trait 109, the higher the mean score the better. It is of course preferable to have a high mean score on the NPS™ because it indicates that customers are indicating that they would recommend a contractor.

Of course, an issue facing an insurer or other user is just how important is the NPS™ trait 109. As FIG. 1 shows, the NPS™ trait 109 is assigned a weight of 20% or simply 0.2. Thus the compliance score trait 109 is slightly more important than average.

Thus weighting of scoring traits has a significant impact on which contractor is referred to a loss. That is to say, weighting assigned to scoring traits 101, 103, 105, 107, 109, 111 effects the overall weighted rank of each contractor. The weighted rank of all the contractors is used in determining whether a contractor is assigned a particular job. Every job that is referred for dispatch to the enterprise that operates the contractor selection server is further referred to a contractor according to a weighted ranking protocol.

Thus FIG. 2, which is a chart 200 illustrating contractor ranks and weighted ranks, is now discussed and described. Chart 200 shows that there are a total of nine (9) contractors that populate a list of potential contractors for a job. That is to say, these nine contractors have met at least one predetermined condition established by a global contractor trait.

The nine contractors are presented on the right side of the chart 200 in a traditional Y-axis direction. The nine contractors are Matrix Restoration 203, Lee Restoration Services 205, Hartford Construction 207, Crosby & Associates 209, Circle Construction 211, Homes by Jake 213, Hi-Point Construction 215, Freeway Construction 217, and K-Pax Construction 219. Each of these nine contractors has a performance metric associated with the six scoring traits described above. As used herein, a performance metric is defined to be a measure of an organization characteristic or an organization's performance, and the expression “performance metric” and the words “metric” are interchangeable. The six scoring traits are provided on the top of the chart 200 in the traditional X-axis directions. Of course the six scoring traits are the proximity trait 202, the job count trait 204, the job volume trait 210, the last job trait 214, the compliance trait 218, and the NPS™ trait 222.

Thus a contractor selection server will store and maintain records that reflect the performance metrics for each of the plurality of contractors for each of the plurality of scoring traits. For example, Matrix Restoration 203 has a performance metric related to the proximity trait 202 of being 12.984 miles away from the site of the loss. Matrix Restoration 203 also has a performance metric related to the job count trait 206 of eleven jobs, indicating that within the last thirty days, Matrix Restoration 203 has been assigned eleven jobs. Matrix Restoration 203 has a performance metric of the job volume trait 210 of $32,394.47, indicating that within the last thirty days, Matrix Restoration 203 has been assigned jobs with estimates totaling $32,394.47. Matrix Restoration 203 has a performance metric of the last job trait 214 that is Apr. 19, 2013 at 4:24 PM, indicating that the last job assigned to Matrix Restoration 203 occurred at that particular date and time. Matrix Restoration 203 has a performance metric of the compliance trait 218 that is 8.00 points. As discussed above, each contractor starts with 10.0 points as it relates to the compliance job trait 218. Therefore at some point Matrix Restoration 203 was docked 2.0 points for below average activity in some compliance area. Matrix Restoration 203 lastly has a performance metric of the NPS™ trait 222 that is 92. As indicated above, scoring related to the NPS™ is either −100, 0, or 100. A 92 in the NPS™ indicates that customer satisfaction with Matrix Restoration 203 is high, and that most customers would recommend the company.

As another example, Circle Construction 211 has a performance metric related to the proximity trait 202 of being 16.178 miles away from the site of the loss. Circle Construction 211 also has a performance metric related to the job count trait 206 of thirteen jobs, indicating that within the last thirty days, Circle Construction 211 has been assigned thirteen jobs. Circle Construction 211 has a performance metric of the job volume trait 210 of $42,455.99, indicating that within the last thirty days, Circle Construction 211 has been assigned jobs with estimates totaling $32,394.47. Circle Construction 211 has a performance metric of the last job trait 214 that is Apr. 21, 2013 at 12:00 AM, indicating that the last job assigned to Circle Construction 211 occurred at that particular date and time. Circle Construction 211 has a performance metric of the compliance trait 218 that is 8.00 points. As discussed above, each contractor starts with 10.0 points as it relates to the compliance job trait 218. Therefore at some point Circle Construction 211 was docked 2.0 points for below average activity in some compliance area. Circle Construction 211 lastly has a performance metric of the NPS™ trait 222 that is 94. As indicated above, scoring related to the NPS™ is either −100, 0, or 100. A 94 in the NPS™ indicates that customer satisfaction with Matrix Restoration 203 is very high, and that most customers would recommend the company.

Thus it should be clear that the contractor selection server will store and maintain records that reflect the performance metrics for each of the plurality of contractors for each of the plurality of scoring traits. The chart 200 will start to be filled. However, the contractors have to be ranked for each of the plurality of scoring traits. That is to say, for each of the plurality of scoring traits, the contractor selection server will assign each of a plurality of contractors a rank 204, 208, 212, 216, 220, 224. It should be noted that all ties in ranking for a particular trait, based on recorded metrics of the contractors, are left as ties in ranking for the particular trait.

As an example, the contractor selection server will rank the contractors for the proximity trait 202. Each of the plurality of contractors will be assigned a rank 204 for the proximity trait 202 by comparing a contractor's performance metric related to the proximity trait 202 with all other contractors' performance metrics related to the proximity trait 202. Thus Matrix Restoration's 203 performance metric with respect to the proximity trait 202 is 12.984 miles, which when compared with all the other contractors' performance metrics with respect to the proximity trait 202, is ranked first (1^{st}). That is to say, the distance of 12.984 miles between Matrix Restoration 203's reported physical location and the referred loss is the smallest distance among all the contractors. The proximity rank 204 of Matrix Restoration 203 is therefore one (1).

As another example, Circle Construction 211's performance metric with respect to the proximity trait 202 is 16.178 miles, which when compared with all the other contractors' performance metrics with respect to the proximity trait 202, is ranked fifth (5^{th}). That is to say, the distance of 16.178 miles between Circle Construction 211's reported physical location and the referred loss is the fifth smallest distance among all the contractors. The proximity rank 204 of Circle Construction 211 is therefore five (5).

As another example, the contractor selection server will rank the contractors for the last job trait 214. Each of the plurality of contractors will be assigned a rank for the last job trait by comparing a contractor's performance metric related to the last job trait 214 with all other contractors' performance metrics related to the last job trait 214. Thus Homes by Jake 213's performance metric with respect to last job trait 214 is Apr. 19, 2013 at 4:34 PM, which when compared with all the other contractors' performance metrics with respect to the last job trait 214, is ranked 5^{th}. That is to say, the date and time of Apr. 19, 2013 at 4:34 PM when Homes by Jake was assigned its last job is 5^{th} furthest/oldest time away from the current time when the present job is being referred. The last job rank 216 of Homes by Jake 213 is therefore 5.

As another example, Hartford Construction's 207 performance metric with respect to the last job trait 214 is Apr. 19, 2013 at 9:22 AM, which when compared with all the other contractors' performance metrics with respect to the last job trait 214, is ranked second (2^{nd}). That is to say, the date and time of Apr. 19, 2013 at 9:22 AM is only the second furthest/oldest time away from the current time when the job is being referred. It should be noted that Crosby & Associates' 230 performance metric with respect to the last job trait 214 is Apr. 18, 2013 at 9:34 AM is the first further time away from the current time when the job is being assigned. The last job rank 216 of Hartford Construction 207 is therefore one (1).

As discussed above, for each of the plurality of scoring traits, the contractor selection server will assign each of a plurality of contractors a rank. That is to say, the ranking by metrics discussed in detailed above is performed by the contractor selection server for each of the scoring trait 202, 206, 210, 214, 218, 222 with respect to each of the contractors 203, 205, 207, 209, 211, 213, 215, 217, 219. The chart 200 will now almost entirely be filled. The only missing items will be the overall weighted rank 226 of the contractors.

Of course as described above, determining weighed rank 226 is a function of the weight assigned to each of the scoring traits 202, 206, 210, 214, 218, 222. In particular, a contractor's overall weighted rank 226 is determined by summing products of the contractor's rank and a trait's weight percentage, for each of the plurality of traits. Examples, of course, help to illustrate this process.

Looking at the contractor Hi-Point Construction 215, the following products of contractor rank and trait weight percentage are obtained:

| Contractor Trait Rank | Trait Weight % | Product |
|---|---|---|
| Proximity Rank (204) = 6 | Proximity Weight % = 0.2 | 1.2 + |
| Job Count Rank (208) = 9 | Job Count Weight % = 0.1 | 0.9 + |
| Job Volume Rank (212) = 9 | Job Volume Weight % = 0.1 | 0.9 + |
| Last Job Rank (216) = 9 | Last Job Weight % = 0.2 | 1.8 + |
| Compliance Rank (220) = 1 | Compliance Weight % = 0.2 | 0.2 + |
| NPS ™ Rank (224) = 2 | NPS ™ Weight % = 0.2 | 0.4 + |
| | Overall Weighted Rank (226) = | 5.40 |

Now looking at the contractor Matrix Restoration 203, the following products of contractor trait rank and trait weight percentage are obtained:

| Contractor Trait Rank | Trait Weight % | Product |
|---|---|---|
| Proximity Rank (204) = 1 | Proximity Weight % = 0.2 | 0.2 + |
| Job Count Rank (208) = 2 | Job Count Weight % = 0.1 | 0.2 + |
| Job Volume Rank (212) = 4 | Job Volume Weight % = 0.1 | 0.4 + |
| Last Job Rank (216) = 4 | Last Job Weight % = 0.2 | 0.8 + |
| Compliance Rank (220) = 4 | Compliance Weight % = 0.2 | 0.8 + |
| NPS ™ Rank (224) = 2 | NPS ™ Weight % = 0.2 | 0.4 + |
| | Overall Weighted Rank (226) = | 2.80 |

The above examples demonstrate how an overall weighted rank 226 for a contractor is determined. The function can be succinctly stated, as indicated above, as summing the products of a contractor's rank and a trait's weight percentage, for each of the plurality of traits. As should be clear, an overall weighted rank 226 is calculated for each contractor 203, 205, 207, 209, 211, 213, 215, 217, 219. In this manner the chart 200 is fully populated.

We can determine from chart 200 that the closest contractor (proximity trait 202 and proximity rank 204) was Matrix Restoration 203. However, it should be noted that this contractor was not ranked first in any other category. Still, Matrix Restoration 203's weighted rank 226 was best at 2.80. The next highest weighted rank 226 was Lee Restoration Services 205 at 3.50.

There are some other interesting things to note about chart 200. For example, Hi-Point Construction 215 comes out with a better overall weighted rank 226 score of 5.40 than Freeway Construction 217, which has overall weighted rank 226 score of 5.50. This is true even though Hi-Point Construction 215 has worse rankings than Freeway Construction 217 in job count rank 208, job volume rank 212, and last job rank 216. This is because the weight assigned to job count (0.1) and job volume (0.1) are lower than the weights assigned to proximity (0.2), compliance score (0.2), and NPS™ (0.2). Therefore, Hi-Point Construction 215 ends up with a better overall weighted rank 226.

This example assumes there were no minority-owned contractors in the list of available contractors. If there had been minority-owned contractors, they would have been ranked the same as the other contractors. Then, if the current allocation of job volume for minority-owned contractors is below the minority preference set aside, any minority-owned contractors would automatically have been placed before all non-minority-owned contractors. If there were more than one minority-owned contractor, the lowest overall weighted rank 226 for minority-owned contractors would be selected.

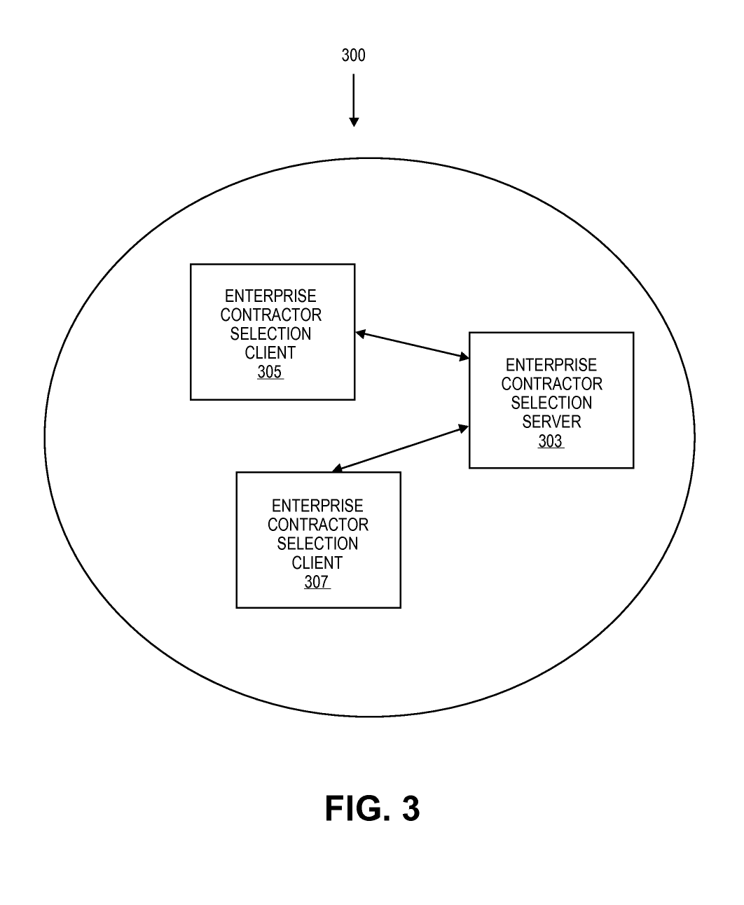

Turning now to FIG. 3, a block diagram illustrating an enterprise contractor selection network 300 is discussed and described. The enterprise contractor selection network 300 includes an enterprise contractor selection server 303 and one or more enterprise contractor selection clients 305, 307. The enterprise contractor selection server 303 may thus be operated by an enterprise that concurrently operates an insurance claims management system, and which refers jobs to sources of loss. manages one or more insurance claims. While some of the functionality of the enterprise contractor selection server 303 may be performed autonomously, network administrators and other employees of the enterprise may program and/or operate the enterprise contractor selection server 303. The enterprise contractor selection server 303 and the enterprise contractor selection client devices 305, 307 may each be communicable with the other over a local area network (LAN), or if the enterprise is large enough, a wide area network (WAN).

Succinctly put, the enterprise contractor selection server 303 is designed to communicate with programmers, administrators, and other enterprise employees who operate the server 303 via other machines on the enterprise networks (of course illustrated in FIG. 3 as enterprise contractor selection client devices 305, 307). Of course, it should be expressly noted that the enterprise contractor selection server 303 may be operated either directly at the device itself or from the enterprise contractor selection client devices 305, 307 over the enterprise contractor selection network 300.

It should also be expressly noted that each of the enterprise contractor selection server 303 and the enterprise contractor selection client devices 305, 307 may communicate with other devices and systems that are not part of the enterprise contractor selection network 300. For example, much of the information related to insurance company trait preferences and customer satisfaction may be provided from devices and systems that are external to the enterprise contractor selection network 300. Bi-directional external communication by the enterprise contractor selection server 303 and the enterprise contractor selection client devices 305, 307 with these outside devices and systems may occur in the same manner as described below with respect to internal communication between the components of the enterprise contractor selection network 300. Thus a detailed discussion of communication protocol between the components of the enterprise contractor selection network 300 and external devices and/or systems is omitted.

Each of the enterprise contractor selection server 303 and the enterprise contractor selection client devices 305, 307 may be viewed as a computer system. As described above, in one embodiment the computer systems 303, 305, 307 may communicate over an enterprise network, however in other embodiments the computer systems 303, 305, 307 may each communicate with the other over any network such as the Internet, an intranet, or any other network. Each computer system 303, 305, 307 may be programmed to operate in automated fashion, and may also have an analog or a graphic user interface such as Outlook and Windows such that users can control computer systems 303, 305, 307. Each computer system 303, 305, 307 may include at least a central processing unit (CPU) with data storage such as disk drives, the number and type of which are variable. In each computer system 303, 305, 307, there might be one or more of the following: a floppy disk drive, a hard disk drive, a solid state drive, a CD ROM or digital video disk, or other form of digital recording device.

Each computer system 303, 305, 307 may include one or more displays upon which information may be displayed. Input peripherals, such as a keyboard and/or a pointing device, such as a mouse, may be provided in each computer system 303, 305, 307 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system 303, 305, 307 may interconnects peripherals previously mentioned herein through a bus supported by a bus structure and protocol. The bus may serve as the main source of communication between components of each computer system 303, 305, 307. The bus in each computer system 303, 305, 307 may be connected via an interface.

The CPU of each computer system 303, 305, 307 may perform the calculations and logic operations required to execute the functionality of each computer system as described in this disclosure and as illustrated in FIGS. 1-2. The functionality of each computer system 303, 305, 307 may be processed in an automated fashion such that relevant data is processed without user administrator assistance or intervention. Alternatively or additionally, the functionality of each computer system 303, 305, 307 may be processed in a semi-automatic fashion with intervention from a user administrator at one or more of the computer systems 303, 305, 307. Implementing, processing, and executing the functionality of each computer system 303, 305, 307 as described in this disclosure with respect to FIGS. 1-2 is within the purview and scope of one of ordinary skill in the art, and is not discussed in detail herein.

Each computer system 303, 305, 307 may be implemented as a distributed computer system or a single computer. Similarly, each computer system 303, 305, 307 may be a general purpose computer, or a specially programmed special purpose computer. Moreover, processing in each computer system 303, 305, 307 may be controlled by a software program on one or more computer systems or processors, or could even be partially or wholly implemented in hardware. The computer systems 303, 305, 307 used in connection with the functionality described with reference to FIGS. 1-2 may rely on the integration of various components including, as appropriate and/or if desired, hardware and software servers, database engines, and/or other content providers.

Although the computer systems 303, 305, 307 in FIG. 3 are each illustrated as being a single computer, each computer system according to one or more embodiments of the invention is optionally suitably equipped with a multitude or combination of processors or storage devices. For example, each computer illustrated in computer systems 303, 305, 307 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system 303, 305, 307 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 303, 305, 307. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more the computer system 303, 305, 307 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 303, 305, 307 may be connected over the Internet, an Intranet, or over a further network. Links to any network may be a dedicated link, a modem over a POTS line, and/or any other method of communicating between computers and/or users.

Each computer system 303, 305, 307 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked. Succinctly put, the computer systems 303, 305, 307 of the contractor selection network may implement the functionality of the various embodiments described herein with respect to FIGS. 1-2 using any imaginable computing environment.

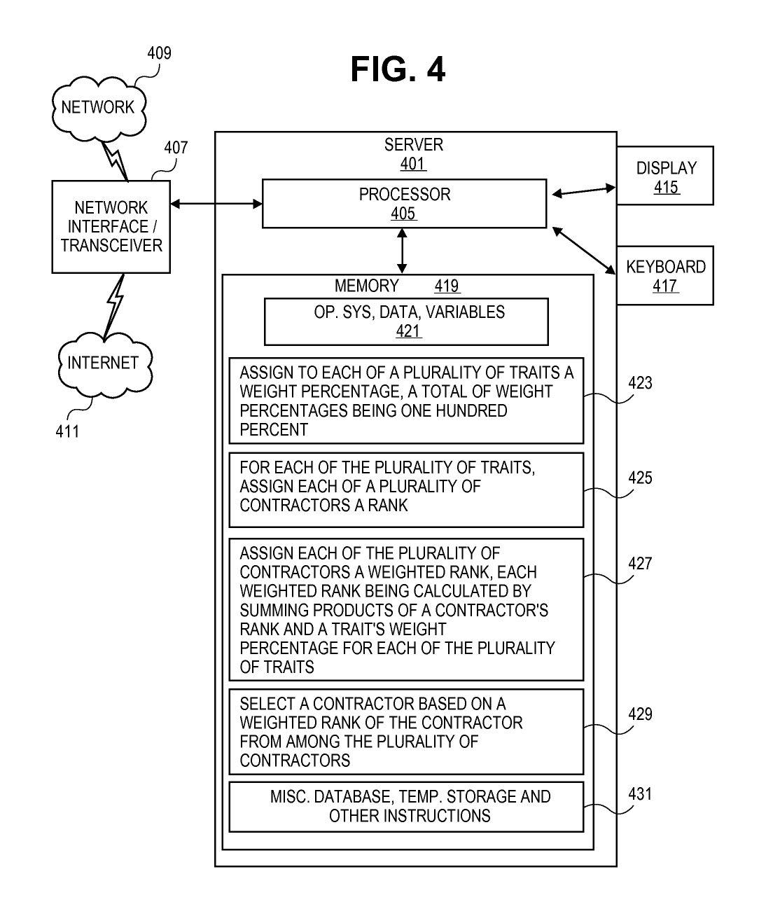

FIG. 4, which is a block diagram illustrating a contractor selection server 401, is now discussed and described. The contractor selection server 401 may include a transceiver 407, a processor 405, a memory 419, a display mechanism 415, and a keypad and/or touch screen 417. The transceiver 407 may be equipped with a network interface that allows the contractor selection server 401 to communicate with other devices in an enterprise or other network 409 or over the Internet 411. Alternatively, the network interface may be provided in separate component coupled with the transceiver 407.

The processor 405 may comprise one or more microprocessors and/or one or more digital signal processors. The memory 419 may be coupled to the processor 405 and may comprise a read-only memory (ROM), a random-access memory (RAM), a programmable ROM (PROM), and/or an electrically erasable read-only memory (EEPROM). The memory 419 may include multiple memory locations for storing, among other things, an operating system, data and variables 421 for computer programs executed by the processor 405.

The computer programs cause the processor 405 to operate in connection with various functions as now described. An assigning weights function 423 causes the processor 405 to assign to each of a plurality of traits a weight percentage, a total of weight percentages being one hundred percent. An assigning rank function 425 causes the processor 405 to, for each of the plurality of traits, assign each of a plurality of contractors a rank. An assigning weighed ranks function 427 causes the processor 405 to assign each of the plurality of contractors a weighted rank, each weighted rank being calculated by summing products of a contractor's rank and a trait's weight percentage for each of the plurality of traits. A select contractor function 431 causes the processor to select a contractor from among the plurality of contractors based on a weighted rank of the contractor.

The above describe functions stored as computer programs may be stored, for example, in ROM or PROM and may direct the processor 405 in controlling the operation of the contractor selection server 401. The memory 419 can additionally store a miscellaneous database and temporary storage 431 for storing other data and instructions not specifically mentioned herein.

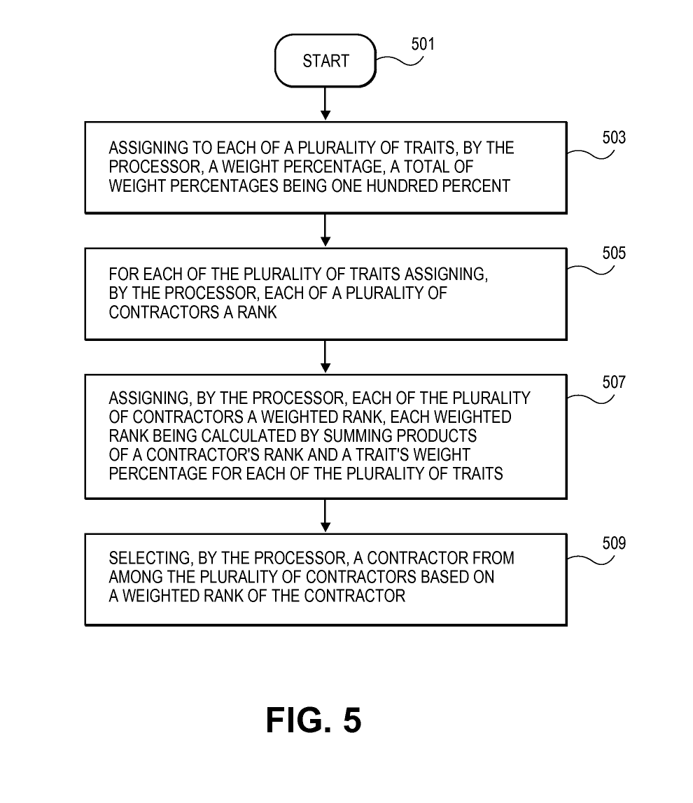

FIG. 5, which is a block diagram illustrating a contractor selection method, is now discussed and described. The contractor selection method is advantageously implemented in a contractor selection server that comprises a transceiver, an electronic data storage, and a processor cooperatively operable with the transceiver and the electronic data storage. When a job is referred to an enterprise which operates the contractor selection server, the contractor selection method begins 501.

The contractor selection method comprises assigning 503 to each of a plurality of traits, by the processor, a weight percentage, a total of weight percentages being one hundred percent. The contractor method further comprises, for each of the plurality of traits assigning 505, by the processor, each of a plurality of contractors a rank. The contractor method additionally comprises assigning 507, by the processor, each of the plurality of contractors a weighted rank, each weighted rank being calculated by summing products of a contractor's rank and a trait's weight percentage for each of the plurality of traits. The contractor selection method lastly comprises selecting 509, by the processor, a contractor from among the plurality of contractors based on a weighted rank of the contractor.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A contractor selection server, comprising:
a transceiver operable to transmit and receive communications over at least a portion of a network;
an electronic data storage; and
a processor cooperatively operable with the transceiver and the electronic data storage, the processor being configured to:
assign to each of a plurality of traits a weight percentage, a total of weight percentages being one hundred percent;
for each of the plurality of traits, assign each of a plurality of contractors a rank;
assign each of the plurality of contractors a weighted rank, each weighted rank being calculated by summing products of a contractor's rank and a trait's weight percentage for each of the plurality of traits; and
select a contractor from among the plurality of contractors based on a weighted rank of the contractor.

2. The contractor selection server according to claim 1, wherein
the processor is configured to assign to each of the plurality of contractors a rank for each of the plurality of traits based on a comparison a contractor's metric related to a trait with all other contractors' metrics related to the trait.

3. The contractor selection server according to claim 2, wherein
the processor is configured to select the contractor from among the plurality of contractors based on the weighted rank of the contractor by determining that the weighted rank of the contractor is lower than all weighted ranks of other contractors among the plurality of contractors.

4. The contractor selection server according to claim 2, wherein
the processor is configured to select the contractor from among the plurality of contractors based on the weighted rank of the contractor by determining that the weighted rank of the contractor is higher than all weighted ranks of other contractors among the plurality of contractors.

5. The contractor selection server according to claim 2, wherein
the processor is further configured to assign a job to the contractor selected based on the weighted rank of the contractor.

6. The contractor selection server according to claim 3, wherein
the processor is further configured to assign a job to the contractor selected based on the weighted rank of the contractor.

7. The contractor selection server according to claim 4, wherein
the processor is further configured to assign a job to the contractor selected based on the weighted rank of the contractor.

8. The contractor selection server according to claim 5, wherein
the plurality of traits includes at least two of proximity to a job site of the job, number of jobs assigned in a predetermined period prior to an assignment date of the job, date of a most recent assigned job prior to the assignment date of the job, total volume by estimate of jobs assigned in a predetermined period prior to the assignment date of the job, customer satisfaction rating, and an enterprise satisfaction rating measuring satisfaction by an enterprise operating the contractor selection server.

9. The contractor selection server according to claim 5, wherein
the plurality of contractors includes only contractors meeting a predetermined condition.

10. The contractor selection server according to claim 9, wherein
the predetermined condition includes a contractor being located within a predetermined distance to a job site of the job.

11. A method of selecting a contractor, implemented in a contractor selection server including a transceiver operable to transmit and receive communications over at least a portion of a network, an electronic data storage, and a processor cooperatively operable with the transceiver and the electronic data storage, the method comprising:
assigning to each of a plurality of traits, by the processor, a weight percentage, a total of weight percentages being one hundred percent;
for each of the plurality of traits assigning, by the processor, each of a plurality of contractors a rank;
assigning, by the processor, each of the plurality of contractors a weighted rank, each weighted rank being calculated by summing products of a contractor's rank and a trait's weight percentage for each of the plurality of traits;
selecting, by the processor, a contractor from among the plurality of contractors based on a weighted rank of the contractor.

12. The method of selecting a contractor according to claim 11, wherein
the assigning of each of the plurality of contractors a weighted rank for each of the plurality of traits is based on a comparison of a contractor's metric related to a trait with all other contractors' metrics related to the trait.

13. The method of selecting a contractor according to claim 12, wherein
selecting the contractor based on the weighted rank of the contractor includes determining, by the processor, that the weighted rank of the contractor is lower than all weighted ranks of other contractors among the plurality of contractors.

14. The method of selecting a contractor according to claim 12, wherein
selecting the contractor based on the weighted rank of the contractor includes determining, by the processor, that the weighted rank of the contractor is higher than all weighted ranks of other contractors among the plurality of contractors.

15. The method of selecting a contractor according to claim 12, further comprising:
assigning a job, by the processor, to the contractor selected based on the weighted rank of the contractor.

16. The method of selecting a contractor according to claim 13, further comprising:
assigning a job, by the processor, to the contractor selected based on the weighted rank of the contractor.

17. The method of selecting a contractor according to claim 14, further comprising:
assigning a job, by the processor, to the contractor selected based on the weighted rank of the contractor.

18. The method of selecting a contractor according to claim 15, wherein
the plurality of traits includes at least two of proximity to a job site of the contracting job, number of jobs assigned in a predetermined period prior to an assignment date of the contracting job, date of a most recent assigned job prior to the assignment date of the contracting job, total volume by estimate of jobs assigned in a predetermined period prior to the assignment date of the contracting job, customer satisfaction rating, and an enterprise satisfaction rating measuring satisfaction by an enterprise operating the contractor selection server.

19. The method of selecting a contractor according to claim 15, wherein
the plurality of contractors includes only contractors meeting a predetermined condition.

20. The method of selecting a contractor according to claim 19, wherein
the predetermined condition is that a contractor must be located within a predetermined distance to a job site of the contracting job.

21. A non-transitory computer-readable storage medium with instructions stored thereon, that when executed by a contractor selection server comprising a transceiver, an electronic data storage, and processor cooperatively operable with the transceiver and the electronic data storage, cause the contractor selection server to perform a method of selecting a contractor, the method comprising:
assigning to each of a plurality of traits a weight percentage, a total of weight percentages being one hundred percent;
for each of the plurality of traits assigning each of a plurality of contractors a rank;
assigning each of the plurality of contractors a weighted rank, each weighted rank being calculated by summing products of a contractor's rank and a trait's weight percentage for each of the plurality of traits;
selecting a contractor from among the plurality of contractors based on a weighted rank of the contractor.

22. The non-transitory computer-readable storage medium according to claim 21, wherein in the method
the assigning of each of the plurality of contractors a weighted rank for each of the plurality of traits is based on a comparison of a measurement of a contractor's performance related to a trait with measurements of all other contractors' performances related to the trait.

23. The non-transitory computer-readable storage medium according to claim 22, wherein in the method
selecting the contractor based on the weighted rank of the contractor includes determining that the weighted rank of the contractor is lower than all weighted ranks of other contractors among the plurality of contractors.

24. The non-transitory computer-readable storage medium according to claim 22, wherein in the method
selecting the contractor based on the weighted rank of the contractor includes determining that the weighted rank of the contractor is higher than all weighted ranks of other contractors among the plurality of contractors.

25. The non-transitory computer-readable storage medium according to claim 22, wherein the method further comprises:
assigning a job to the contractor selected based on the weighted rank of the contractor.

26. The non-transitory computer-readable storage medium according to claim 23, wherein the method further comprises:
assigning a job to the contractor selected based on the weighted rank of the contractor.

27. The non-transitory computer-readable storage medium according to claim 24, wherein the method further comprises:
assigning a job to the contractor selected based on the weighted rank of the contractor.

28. The non-transitory computer-readable storage medium according to claim 25, wherein in the method
the plurality of traits includes at least two of proximity to a job site of the contracting job, number of jobs assigned in a predetermined period prior to an assignment date of the contracting job, date of a most recent assigned job prior to the assignment date of the contracting job, total volume by estimate of jobs assigned in a predetermined period prior to the assignment date of the contracting job, customer satisfaction rating, and an enterprise satisfaction rating measuring satisfaction by an enterprise operating the contractor selection server.

29. The non-transitory computer-readable storage medium according to claim 25, wherein in the method
the plurality of contractors includes only contractors meeting a predetermined condition.

30. The non-transitory computer-readable storage medium according to claim 29, wherein in the method
the predetermined condition is that a contractor must be located within a predetermined distance to a job site of the contracting job.
